(19) United States
(12) Patent Application Publication
(10) Pub. No.: US 2026/0081049 A1
(43) Pub. Date: Mar. 19, 2026

(54) RADIONUCLIDE SEPARATING APPARATUS AND FLUID RECOVERY METHOD USING THE SAME

(71) Applicant: KOREA ATOMIC ENERGY RESEARCH INSTITUTE, Daejeon (KR)

(72) Inventors: Jong Kwang LEE, Daejeon (KR); Byung Suk PARK, Daejeon (KR); Simon OH, Daejeon (KR); Jiyong KIM, Daejeon (KR); Jungbo YOO, Seoul (KR); Tae-Hong PARK, Sejong-si (KR); Hwan Seo PARK, Daejeon (KR)

(73) Assignee: KOREA ATOMIC ENERGY RESEARCH INSTITUTE, Daejeon (KR)

(21) Appl. No.: 19/326,996

(22) Filed: Sep. 12, 2025

(30) Foreign Application Priority Data
Sep. 13, 2024 (KR) 10-2024-0126055

(51) Int. Cl. G21F 9/12; G21F 9/00

(52) U.S. Cl. CPC G21F 9/12; G21F 9/007

(57) ABSTRACT

Disclosed is an apparatus for separating a desired radionuclide. The apparatus includes a fluid supply part that supplies a fluid including a sample containing the radionuclide or a reagent, a column separation part that receives the fluid supplied from the fluid supply part and separate the radionuclide, and including a driving member passage, through which the fluid, from which the radionuclide has been separated, is discharged, a fluid recovery part including a plurality of recovery containers that recover the fluid discharged through the column separation part, a sensor that senses the fluid in the column separation part, and a controller that controls driving of the fluid supply part, the column separation part, and the fluid recovery part such that, after residual fluid remaining in an interior of the driving member passage is recovered into the recovery container, the recovery container located at a recovery position is replaced.

### CROSS-REFERENCE TO RELATED APPLICATION

This application claims the benefit of priority to Korean Patent Application No. 10-2024-0126055, filed in the Korean Intellectual Property Office on Sep. 13, 2024 the entire contents of which are incorporated herein by reference.

### TECHNICAL FIELD

The present disclosure relates to a radionuclide separating apparatus and a fluid recovery method using the same.

### BACKGROUND

Among radionuclides that are present in radioactive waste, nuclides that emit gamma rays may be easily measured in nondestructive methods, but nuclides that emit alpha particles, beta particles, and low-energy gamma rays are difficult to measure directly due to high self-absorption of alpha particles and low energy resolution of beta spectra, and thus, have to be individually separated from matrix elements.

Column chromatography-based concentration, separation, and purification techniques are widely used to chemically separate radionuclides. Generally, to individually separate target nuclides from various matrix elements contained in a single sample, a multi-stage process including initialization, sample loading, purification, elution, and washing is required, and for each operation, through a pretreatment process, a liquefied sample or a reagent that is necessary for the separation process is introduced into a resin column that is provided to meet the characteristics of the radionuclide to be separated and pass therethrough at a constant flow rate. Through the process, a process of removing interfering substances, adsorbing radionuclides to separate them from the fluid, and desorbing the adsorbed radionuclides, the sample or reagent is recovered.

A recovery rate that is a key performance indicator of the radionuclide separating process varies depending on the physicochemical properties of a resin and flow of the sample that passes through the column, and the conventional gravity separation scheme requires a significant amount of time and labor because the flow cannot be controlled and the entire process is performed manually.

Accordingly, there is a need for a method that allows the flow to be easily controlled, enables each process to be responded to quickly so that the fluid sequentially discharged in the separation process may be discharged and recovered rapidly and accurately, and increases a recovery rate of the fluid in each process.

### PRIOR ART DOCUMENTS

### Patent Document

Korean Patent No. 10-2445313 (registered on Sep. 15, 2022)

### SUMMARY

The present disclosure has been made to solve the above-mentioned problems occurring in the prior art while advantages achieved by the prior art are maintained intact.

An aspect of the present disclosure provides a radionuclide separating apparatus capable of rapidly and accurately recovering fluid sequentially discharged during a radionuclide separating process, and a fluid recovery method using the same.

An aspect of the present disclosure also provides a radionuclide separating apparatus capable of increasing a recovery rate of fluid, and a fluid recovery method using the same.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for separating a desired radionuclide includes a fluid supply part that supplies a fluid including a sample containing the radionuclide or a reagent, a column separation part that receives the fluid supplied from the fluid supply part and separate the radionuclide, and including a driving member passage, through which the fluid, from which the radionuclide has been separated, is discharged, a fluid recovery part including a plurality of recovery containers that recover the fluid discharged through the column separation part, a sensor that senses the fluid in the column separation part, and a controller that controls driving of the fluid supply part, the column separation part, and the fluid recovery part such that, after residual fluid remaining in an interior of the driving member passage is recovered into the recovery container, the recovery container located at a recovery position is replaced.

### BRIEF DESCRIPTION OF THE DRAWINGS

The above and other objects, features and advantages of the present disclosure will be more apparent from the following detailed description taken in conjunction with the accompanying drawings:

FIG. 1 is a view schematically illustrating a apparatus according to the present radionuclide separating disclosure;

FIG. 2 is a view illustrating a column separation part, a sensor, and a controller of the radionuclide separating apparatus of FIG. 1;

FIG. 3 is a flowchart illustrating an overall process of a radionuclide separating process;

FIG. 4 is a flowchart illustrating a fluid recovery method using the radionuclide separating apparatus according to the present disclosure;

FIG. 5 is a view schematically illustrating some operations of the fluid recovery method of FIG. 4; and

FIG. 6 is a view schematically illustrating other operations of the fluid recovery method of FIG. 4.

### DETAILED DESCRIPTION

Hereinafter, some embodiments of the present disclosure will be described in detail with reference to the accompanying drawings. In the drawings, the same reference numerals will be used throughout to designate the same or equivalent components. In describing embodiments of the present disclosure, detailed descriptions associated with well-known functions or configurations will be omitted if they may make subject matters of the present disclosure unnecessarily obscure.

Furthermore, in describing components of embodiments of the present disclosure, the terms first, second, A, B, (a), (b), and the like may be used herein. These terms are only used to distinguish one component from another component, but do not limit the corresponding components irrespective of the nature, order, or priority of the corresponding components. When it is described that a certain component is “connected to”, “coupled to” or “electrically connected to” a second component, it should be understood that the component may be directly connected or electrically connected to the second component, but a third component may be “connected”, “coupled” or “electrically connected” between the components.

In the specification, a forward/rearward direction, a leftward/rightward direction, and an upward/downward direction are referred for convenience, and may be directions that are perpendicular to each other.

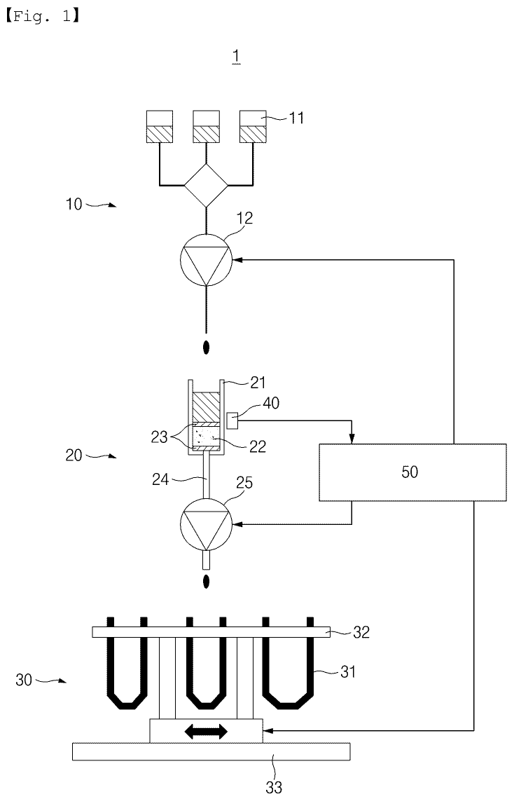

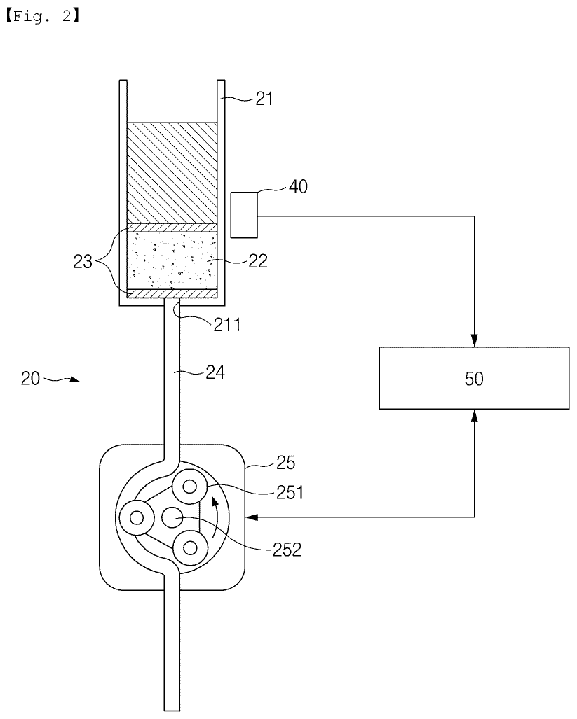

FIG. 1 is a view illustrating schematically a radionuclide separating apparatus 1 according to the present disclosure, and FIG. 2 is a view illustrating a column separation part 20, a sensor 40, and a controller 50 of the radionuclide separating apparatus 1 of FIG. 1. Referring to FIGS. 1 and 2, the radionuclide separating apparatus 1 according to the present disclosure will be described.

The radionuclide separating apparatus 1 according to the present disclosure may be understood as an apparatus that purifies elements that interfere with or disturb radioactivity measurement from a liquefied radioactive waste sample containing various chemical elements by using a reagent, and efficiently separates and recovers a fluid containing a desired radionuclide.

Specifically, the radionuclide separating apparatus 1 according to the present disclosure may separate and recover only a radionuclide to be recovered through processes of adsorbing and desorbing the radionuclide contained in a fluid. That is, the radionuclide separating apparatus 1 is directed to removing undesired radionuclides and other components and purifying and recovering a desired radionuclide. In this case, it is possible to individually separate and recover a single radionuclide to be recovered, or, when there are several radionuclides to be recovered, to recover a fluid containing all of them as one group.

However, the spirit of the present disclosure is not limited thereto, and it may also be understood as an apparatus that efficiently separates and recovers a fluid containing a desired component and a fluid containing undesired components in a column chromatography process for separating or purifying various chemical components from a general mixture.

Specifically, the radionuclide separating apparatus 1 according to the present disclosure may control a column flow by utilizing a sensor 40 that senses a fluid. Accordingly, it may be possible to rapidly and accurately separate and recover sequentially discharged fluids, and a residual fluid that remains in a driving member passage 24 may be recovered into an appropriate recovery container 31, so that a recovery rate may be increased.

The radionuclide separating apparatus 1 includes a fluid supply part 10 that supplies a fluid, such as a sample containing the radionuclide or a reagent that is necessary for a radionuclide separating process, a column separation part 20 that receives the fluid supplied from the fluid supply part 10 and separates and purifies the radionuclide, and including a driving member passage 24, through which the purified fluid is discharged, a fluid recovery part 30 including a plurality of recovery containers 31 that separates and recover the fluid discharged through the column separation part 20, a sensor 40 that senses the fluid in the column separation part 20, and a controller 50 that controls driving of the fluid supply part 10, the column separation part 20, and the fluid recovery part 30 such that, after residual fluid that remains in an interior of the driving member passage 24 is recovered into the recovery container 31, the recovery container 31 located at a recovery position is replaced.

The fluid supply part 10 may sequentially supply a fluid such as the radionuclide-containing sample liquefied through a pretreatment process and various reagents to the column separation part 20. Specifically, the fluid may be understood as including both the sample containing a desired radionuclide and the reagent required for the radionuclide separating process. The sample or the reagent to be supplied may vary depending on the radionuclide separating process.

The supplied fluid may be accommodated in different types of supply containers 11 depending on radionuclide separation characteristics. For this purpose, a plurality of supply containers 11 may be provided in the fluid supply part 10. FIG. 1 illustrates, as an example, a case, in which three supply containers 11 are provided, but the spirit of the present disclosure is not limited thereto.

The fluid supply part 10 may include a supply pump 12 that generates power to transfer the fluid accommodated in the supply container 11. The supply pump 12 may be provided as various types of pumps, such as a reciprocating pump, a rotary pump, or a piston pump, but is not limited thereto.

In the embodiment, as an example, automatic supply of the fluid through the supply pump 12 of the fluid supply part 10 under control of the controller 50 has been described, but the spirit of the present disclosure is not limited thereto.

As an example, the fluid may be supplied to the column container 21 through a separate fluid supply part (not illustrated) that directly supplies the fluid or utilizes a disposable syringe or a disposable pipette, without passing through the fluid supply part 10, to reduce the possibility of cross-contamination. Furthermore, the fluid supply part 10 may also be provided in a configuration, in which the fluid is supplied manually by a user without control of the controller 50. As another example, the sample containing radionuclides and the reagent may be supplied separately, and in this case, for convenience, at least one of them may be supplied directly to the column container 21.

Accordingly, in the radionuclide separating apparatus 1 according to the present disclosure, control of the fluid supply part 10 should be broadly understood as including not only active control of automatically transferring a predetermined amount of fluid, such as a sample or a reagent, to the column container 21 through the fluid supply part 10, but also passive control of sensing that the fluid has been supplied to the column container 21, through the sensor 40.

The column separation part 20 includes a column container 21 that accommodates the fluid supplied during a fluid supply operation and has an outlet 211, through which the fluid is discharged, at one side thereof, an adsorption member 22 and a filter member 23 that are disposed in an interior of the column container 21 to separate a radionuclide contained in the fluid, a driving member 25 that provides power such that the fluid flows, and a driving member passage 24 that is connected to the outlet 211 of the column container 21 to discharge the fluid toward the fluid recovery part 30.

The column separation part 20 may be provided on one side of the fluid supply part 10 and, as an example, may be disposed on a lower side of the fluid supply part 10, as illustrated in FIG. 1.

An adsorption member 22 that is selected depending on the chemical characteristics of a radionuclide to be separated may be filled at a lower portion of the column container 21. It is preferable that filter members 23 are provided on an upper surface and a lower surface of the adsorption member 22 to prevent loss of the adsorption member 22 and also to prevent the adsorption member 22 from being disturbed by the fluid supplied into the column container 21. The adsorption member 22 may, as an example, be an ion exchange resin or an extraction chromatographic resin, but is not limited thereto, and may be variously formed depending on characteristics of a radionuclide to be separated. The filter member 23 may also have pores of various sizes and shapes depending on characteristics of the radionuclide separating process.

The present disclosure may recover residual fluid that is inevitably generated in an apparatus that controls a flow by utilizing the sensor 40, by sequentially performing processes, such supplying a new fluid, recovering residual fluid, replacing a recovery container, and recovering the supplied fluid. A detailed description thereof will be made later.

Meanwhile, the driving member 25 may discharge the supplied fluid to the outlet 211 of the column container 21 after allowing the fluid to pass through the adsorption member 22 and the filter member 23 in the interior of the column container 21. The driving member 25 may be a fluid pump, such as a gear pump, a diaphragm pump, a peristaltic pump, or a piston pump.

FIG. 2 illustrates, as an example of the driving member 25, a case, in which a peristaltic pump is applied, and the driving member passage 24 may be a single flexible tube. The driving member 25 may include a rotary shaft 252 and a plurality of rollers 251 that are rotate about the rotary shaft 252. As the plurality of rollers 251 are rotated about the rotary shaft 252, the driving member passage 24 may be repeatedly compressed and released to move fluid.

The driving member passage 24 may be formed of a material having elasticity so that, when an external force is applied, its shape is changed, and when the applied external force is released, it may be restored to its original state. The fluid may flow through a series of processes, in which the driving member passage 24 is pressed by the rollers 251, its shape is temporarily changed, a pressure is generated in the interior of the driving member passage 24, and the pressure applied to the driving member passage 24 is released.

The fluid recovery part 30 may include a plurality of recovery containers 31 that separates and recovers the fluid discharged through the column separation part 20, a support member 32 that supports the recovery containers 31, and a movement member 33 that moves the support member 32.

In this case, the movement member 33 may include a linear motion stage (not illustrated) that linearly moves the plurality containers 31, and a rotary motion stage (not of recovery illustrated) that rotates the support member 32 about a fixed shaft to rotationally move the plurality of recovery containers 31. Accordingly, the recovery container 31 may be moved linearly or may be rotationally moved about the fixed shaft.

By operating the movement member 33 as described above, the recovery container 31 may be moved to a recovery position, and the recovery container 31 that has been moved to the recovery position may collect the fluid discharged through the driving member passage 24. In this case, the fluid may be collected into different recovery containers 31 depending on its application, and for this purpose, a plurality of recovery containers 31 may be provided in the fluid recovery part 30. FIG. 1 illustrates, as an example, a case, in which three recovery containers 31 are disposed linearly, but the spirit of the present disclosure is not limited thereto, and a different number of recovery containers 31 may be disposed in various ways depending on characteristics of the radionuclide separating process and types of radionuclides to be separated.

Meanwhile, a noncontact sensor 40 may be provided at one side of the column container 21. The sensor 40 may be installed outside of the column container 21 not to impede fluid flow. In this case, the sensor 40 may be provided as a sensor that senses the fluid accommodated in the interior of the column container 21. As an example, various sensors, such as an optical sensor, an ultrasonic sensor, a radar sensor, a thermal sensor, a vibration sensor, an electric conductivity sensor, or a capacitance sensor, may be used, but the type of the sensor 40 is not limited thereto.

Specifically, after a specific amount of fluid is supplied to the column container 21, the fluid may flow downward in the column container 21 by driving of the driving member 25. Accordingly, the fluid may flow through the adsorption member 22 and the filter member 23 disposed in the column container 21, and then may be discharged through the outlet 211. The sensor 40 may be disposed at an upper side of the adsorption member 22 and the filter member 23, and may sense a time point, at which the fluid in the interior of the column container 21 is all introduced into the adsorption member 22 and the filter member 23. That is, the sensor 40 may sense a time point, at which no fluid remains on an upper side of the adsorption member 22 and the filter member 23 in the column container 21.

Referring to FIGS. 1 and 2, the controller 50 may generate, edit, and load process information or control information that is required for the radionuclide separating process, and may control driving of the fluid supply part 10, the column separation part 20, and the fluid recovery part 30 based on information sensed by the sensor 40.

For this purpose, the type and volume of a supply reagent for controlling the operations of the radionuclide separating process, a position of the recovery container 31, and an internal volume value of the driving member passage 24 may be input to the controller 50. The controller 50 may control a driving time period of the driving member 25 for recovering the residual fluid that remains in the interior of the driving member passage 24, depending on the internal volume value of the driving member passage 24 that is input to the controller 50.

Specifically, after it is sensed by the sensor 40 that the fluid has been supplied to the column container 21, the controller 50 may drive the driving member 25 to recover the residual fluid. In this case, the driving member 25 may be operated for a recovery time period corresponding to the internal volume value of the driving member passage 24. Thereafter, the controller 50 may drive the fluid recovery part 30 to replace the recovery container 31. Thereafter, the controller 50 may drive the driving member 25 such that the supplied fluid is recovered into the changed recovery container 31. In this case, the controller 50 may control the driving member 25 such that the driving member 25 is driven until a sensing time point of the fluid by the sensor 40. Specifically, the driving member 25 may be driven until a time point, at which it is sensed by the sensor 40 that all of the fluid in the interior of the column container 21 has flowed into the adsorption member 22 and the filter member 23. Thereafter, the controller 50 may control the fluid supply part 10 such that new fluid is supplied into the column container 21. After the new fluid is supplied into the column container 21, the controller 50 may drive the driving member 25 again to recover the residual fluid. The controller 50 may control driving of the fluid supply part 10, the column separation part 20, and the fluid recovery part 30 so that the process is repeated.

On the other hand, controlling a driving time period implies a composite meaning. As an example, when a peristaltic pump is used as the driving member 25, as illustrated in FIG. 2, the driving member passage 24 may be a flexible tube. A pulse driving scheme may be applied to rotate the peristaltic pump, and in this case, the pump may be rotated by an angle corresponding to each pulse. In this case, as a frequency of the pulse train increases, the pump may be rotated at a high speed. Accordingly, a volume of fluid transferred through the driving member 25 increases as the number of control pulses increases or as the driving time period becomes longer for a pulse train of a specific frequency. However, because an increase in the driving time period and a volume of the transferred fluid are proportional to each other in both cases, controlling the driving time period should be understood to include both directly controlling a time period, for which pulses are applied, and controlling the number of pulses.

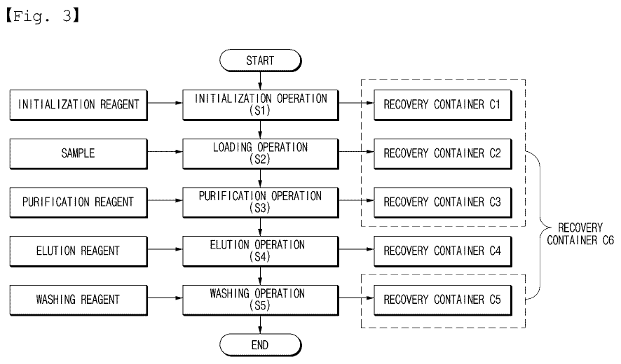

FIG. 3 is a flowchart illustrating an overall process of a radionuclide separating process. Referring to FIG. 3, a process of performing a multi-stage radionuclide separating process by the radionuclide separating apparatus 1 may be divided into an initialization operation S1, a sample loading operation S2, a purification operation S3, an elution operation S4, and a washing operation S5.

First, in the initialization operation (conditioning operation) S1, an initialization reagent (conditioning reagent) may be supplied into the column container 21 through the fluid supply part 10. Furthermore, the initialization reagent that has passed through the column separation part 20 may be recovered into the recovery container C1. The initialization reagent used in the initialization operation S1 refers to a reagent for initializing (conditioning) the adsorption member 22.

In the sample loading operation S2, a sample containing a desired radionuclide to be separated may be supplied into the column container 21 directly or through the fluid supply part 10. Furthermore, after the desired radionuclide in the sample has been adsorbed to the adsorption member 22 while passing through the column separation part 20, the fluid discharged therefrom may be recovered into the recovery container C2.

The sample loading operation S2 is an operation for adsorbing a radionuclide to be separated, but in the sample loading operation S2, in addition to the desired radionuclide, components with similar chemical behavior to the desired radionuclide may also be partially adsorbed to the adsorption member 22. In this way, when components other than the desired radionuclide are adsorbed to the adsorption member 22 together, the purification operation S3 may be performed to desorb the other components from the adsorption member 22.

In the purification operation (rinsing operation) S3, a purification reagent (rinsing reagent) may be supplied into the column container 21. The purification reagent refers to a reagent for desorbing other components adsorbed to the adsorption member 22 in the sample loading operation S2. By performing the purification operation S3, the adsorption member 22 may be in a state, in which only the desired radionuclide is adsorbed thereto. Furthermore, the fluid discharged after the reagent has passed through the column separation part 20 may be recovered into the recovery container C3.

In an elution operation S4, an elution reagent may be supplied into the column container 21. The elution reagent refers to a reagent for desorbing the desired radionuclide from the adsorption member 22. The fluid discharged after passing through the column separation part 20 may be recovered into the recovery container C4.

In the elution operation S4, the desired radionuclide is desorbed from the adsorption member 22 by the elution reagent, so that the fluid containing the desired radionuclide may be recovered into the recovery container C4.

In a washing operation (cleaning-up operation) S5, an acid or distilled water may be supplied into the column container 21 to wash (clean up) the column container 21, the adsorption member 22, the driving member passage 24, and the like. In the washing operation S5, the fluid discharged after passing through the column separation part 20 is recovered into the recovery container C5. By performing the washing operation S5, the radionuclide separating operation may be completed.

A plurality of recovery containers 31 that recover the fluid in each process operation may separate and recover fluid that contains the desired radionuclide and the fluid that does not contain the desired radionuclide. Accordingly, as described above, all of the separated fluids may be individually recovered and collected in the recovery containers C1 to C5, or, in another example, the fluid that does not contain the desired radionuclide may be defined as waste fluid, and the fluids discharged in the initialization operation S1, the sample loading operation S2, the purification operation S3, and the washing operation S5 may be recovered and collected in a single recovery container C6.

As described above, in the radionuclide separating process, adsorption and desorption processes are performed, and in the specification, the term “separation” means adsorbing or desorbing what has been adsorbed depending on the type of fluid supplied, so that ultimately the desired radionuclide is separated.

Meanwhile, in general, to increase a recovery rate of the radionuclide, the above processes may be combined and performed in multiple stages. Accordingly, some operations of the radionuclide separating process may be omitted or repeated, and the sequence may also be different from that described above.

In the fluid recovery method according to the present disclosure, in order to further increase the recovery rate, when any one of the initialization operation S1, the sample loading operation S2, the purification operation S3, the elution operation S4, and the washing operation S5 of FIG. 3 is performed, the driving member 25 may be controlled by utilizing internal volume information of the driving member passage 24 together with sensor 40 information so that the residual fluid that remains in the driving member passage 24 may be recovered into an appropriate recovery container 31.

In particular, in an apparatus, in which the driving member passage 24 is provided at a lower end (outlet) of the column container 21, all of the supplied fluid may be recovered into desired recovery containers. Through this, it is possible to exclude the influence of the internal volume of the driving member passage 24 and more accurately separate and recover fluid containing the desired radionuclide.

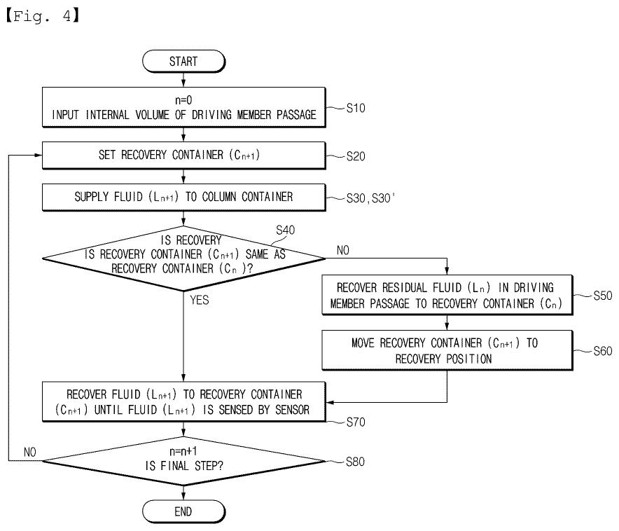

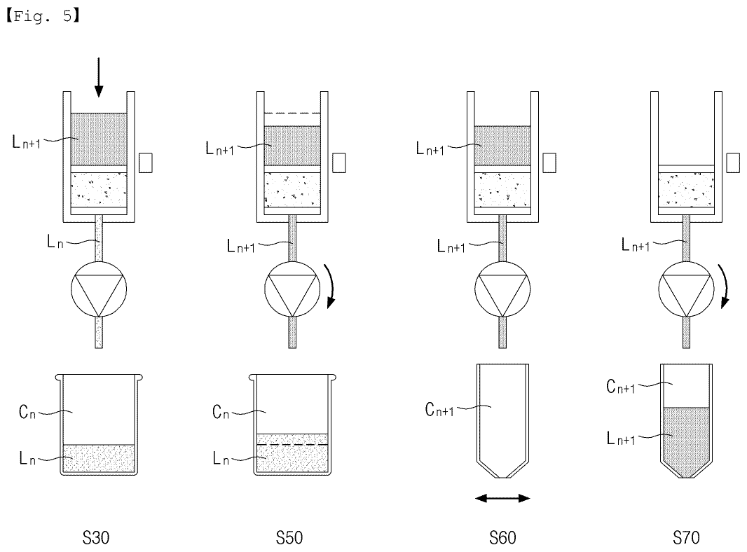

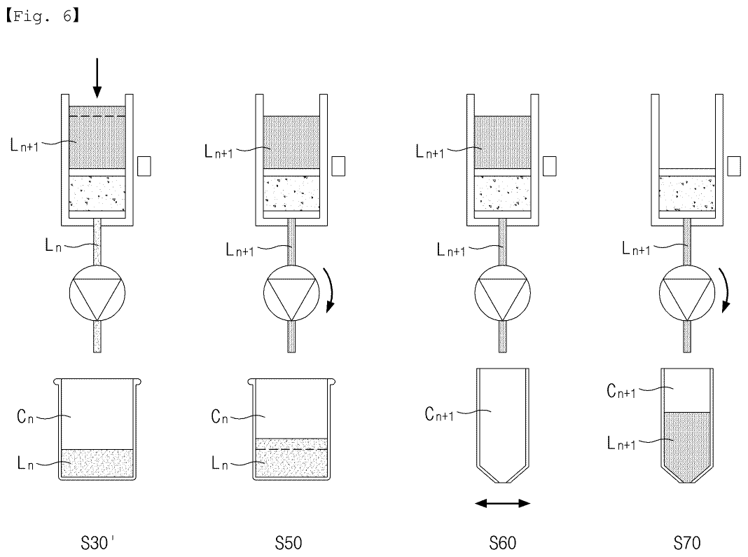

FIG. 4 is a flowchart illustrating a fluid recovery method using the radionuclide separating apparatus 1 according to the present disclosure, FIG. 5 is a view schematically illustrating some operations of the fluid recovery method of FIG. 4, and FIG. 6 is a view schematically illustrating other operations of the fluid recovery method of FIG. 4. Hereinafter, a fluid recovery method using the radionuclide separating apparatus 1 according to the present disclosure will be described with reference to FIGS. 4 to 6.

Referring to FIG. 4, a fluid recovery method using the radionuclide separating apparatus 1 according to the present disclosure may include a volume input operation S10 of inputting an internal volume value of the driving member passage 24, an operation S20 of setting a recovery container Cₙ₊₁ for recovering fluid Lₙ₊₁, a fluid supply operation S30 and S30′ of supplying the fluid Lₙ₊₁ into the column container 21, an operation S40 of determining whether the previous operation recovery container Cₙ and the current operation recovery container Coni are the same, a residual fluid recovery operation S50 of recovering residual fluid Lₙ that remains in the driving member passage 24 into the recovery container Cₙ, a recovery container changing operation S60 of moving the recovery container Con for recovering the fluid Lₙ₊₁, to a recovery position, a fluid recovery operation S70 of operating the driving member 25 until a sensing time point of the fluid Lₙ₊₁ by the sensor 40 so that the fluid Lₙ₊₁ that has passed through the column separation part 20 is recovered into the recovery container Cₙ₊₁, and an operation S80 of determining whether the operation is a final operation of the radionuclide separating process. Here, n is a natural number, and may have a value that increases by 1 after the fluid recovery operation S70.

In an initial operation using the radionuclide separating apparatus 1 according to the present disclosure, the fluid recovery part 30 may be moved to an origin, and accordingly, an initial recovery container C₀ may be disposed at the recovery position. Furthermore, in the residual fluid recovery operation S50, an internal volume value of the driving member passage 24 may be input (S10) to set a driving time period, for which the driving member 25 is driven.

The residual fluid recovery operation S50 may be performed for a recovery time period corresponding to the internal volume value of the driving member passage 24 that has been input. Specifically, in the volume input operation S10, a time period, for which the residual fluid recovery operation S50 is performed, may be calculated depending on the internal volume value of the driving member passage 24, and the driving member 25 may be driven in the residual fluid recovery operation S50 for the calculated driving time period.

For this purpose, the controller 50 may set control parameters, such as a volume of the supply fluid Lₙ₊₁, a flow velocity of the fluid Lati in the column separation part 20, and the recovery container Cₙ₊₁. However, to reduce the possibility of cross-contamination, when the supply fluid Lₙ₊₁ is directly supplied into the column container 21 or when a volume of the supply fluid Lₙ₊₁ is not accurately known, the volume of the supply fluid Lati may not be input. However, even when a volume of the supply fluid Lₙ₊₁ is not input, the multi-stage fluid recovery method according to the present disclosure may be performed effectively. A more detailed description related to fluid supply and fluid recovery will be provided below.

FIG. 5 illustrates an example of a fluid recovery method including the fluid supply operation S30, the residual fluid recovery operation S50, the recovery container changing operation S60, and the fluid recovery operation S70.

First, the fluid Lₙ₊₁ may be supplied into the column container 21 by various schemes (S30). As described above, the supply fluid Lₙ₊₁ containing a sample or a reagent, may be supplied in a set volume through an operation of the supply pump 12 by the controller 50, or may be supplied by a separate fluid supply part (not illustrated) utilizing a disposable syringe or pipette. In another example, the supply fluid Lₙ₊₁ may be supplied directly into the column container 21 without passing via the fluid supply part 10.

After the fluid Lₙ₊₁ is supplied into the column container 21, the residual fluid Lₙ may be recovered into the recovery container Cₙ (S50). Specifically, the controller 50 may drive the driving member 25 for a recovery time period corresponding to the internal volume value of the driving member passage 24 that has been input in the volume input operation S10. That is, when all of the residual fluid Lₙ has been recovered, the driving of the driving member 25 may be stopped. Accordingly, only the residual fluid Lₙ may be recovered into the recovery container Cₙ located at the recovery position, and the fluid Lₙ₊₁ supplied in the fluid supply operation S30 may not be recovered into the recovery container Cₙ.

After the residual fluid Lₙ is recovered, the next recovery container Cₙ₊₁ may be located at the recovery position (S60). Specifically, the controller 50 may drive the movement member 33 such that the recovery container Cₙ₊₁ set in the recovery container setting operation S20 is located at the recovery position.

After the recovery container Cₙ₊₁ has been moved to the recovery position, the fluid Lₙ₊₁ supplied in the fluid supply operation S10 may be recovered into the recovery container Cₙ₊₁ by operating the driving member 25 (S70). When the driving member 25 is driven, the fluid Lₙ₊₁ may be moved downward while passing through the adsorption member 22 and the filter member 23 inside the column container 21, and accordingly, a surface of the fluid Lₙ₊₁ may be gradually lowered. When the surface of the fluid Lₙ₊₁ reaches a sensing position of the sensor 40, the operation of the driving member 25 may be stopped. In this case, the fluid Lₙ₊₁ may remain in the driving member passage 24. For recovery of the residual fluid Lₙ₊₁, the above operations, such as supplying the fluid Lₙ₊₂ and recovering the residual fluid Lₙ₊₁ may be repeated in the subsequent operation.

FIG. 6 illustrates still another example of a fluid recovery method including the fluid supply operation S30′, the residual fluid recovery operation S50, the recovery container changing operation S60, and the fluid recovery operation S70. More specifically, FIG. 6 illustrates a fluid recovery method capable of recovering a desired amount of fluid Lₙ₊₁ without using the subsequent fluid Lₙ₊₂.

In the present disclosure, the amount of the supplied fluid in the fluid supply operation S30 and S30′ may be adjusted so that a target amount of fluid may be recovered without using the subsequent fluid. An amount of fluid supplied in the fluid supply operation S30 and S30′ may vary depending on a determination result in the operation S80 of determining whether the operation is a final operation of the radionuclide separating process. Specifically, when it is determined to be the final operation in the operation S80 of determining whether the radionuclide separating process is a final operation, a larger amount of fluid Lati may be supplied to recover the same amount of fluid Lati as in the previous operation without using the subsequent fluid Lₙ₊₂.

Specifically, the amount of the fluid Lₙ₊₁ supplied in the final fluid supply operation S30′ may be an amount obtained by adding an amount that is required for the radionuclide separating process and an amount corresponding to the internal volume of the driving member passage 24. That is, in the fluid supply operation S30′ of a process that does not use the subsequent fluid Lₙ₊₂, an amount of fluid that is larger by an amount corresponding to the internal volume of the driving member passage 24 than the amount of fluid supplied in the fluid supply operation S30 of a process that uses the subsequent fluid Lₙ₊₂ may be supplied.

Meanwhile, in the residual fluid recovery operation S50, the driving member 25 may be driven for a recovery time period corresponding to the internal volume value of the driving member passage 24 that has been input in the volume input operation S10. Accordingly, only the residual fluid Lₙ may be recovered into the recovery container Cₙ located at the recovery position.

After the residual fluid Lₙ is recovered, the next recovery container Cₙ₊₁ may be located at the recovery position (S60). Specifically, the controller 50 may drive the movement member 33 such that the recovery container Cₙ₊₁ set in the recovery container setting operation S20 is located at the recovery position.

After the recovery container Cₙ₊₁ has been moved to the recovery position, the supplied fluid Lₙ₊₁ may be recovered into the recovery container Cₙ₊₁ by operating the driving member 25 (S70). The driving member 25 may be stopped when a surface of the fluid Lₙ₊₁ reaches a sensing position of the sensor 40.

Through this process, the fluid recovery method of FIG. 6 may recover an amount of fluid Lₙ₊₁ that is required for the process into the recovery container Cₙ₊₁ without using the subsequent fluid Lₙ₊₂ in a final operation of the multi-stage separation process.

Meanwhile, the same recovery container may be used in two consecutive fluid recovery operations according to the radionuclide separating process. Although omitted in FIGS. 5 and 6, it may be determined whether the previous recovery container Cₙ and the recovery container Cₙ₊₁ for recovering the fluid Lₙ₊₁ supplied in the S30 operation are the same (S40). When it is determined that the recovery container Cₙ located at the recovery position and the recovery container Con set in the S20 operation are the same, the residual fluid recovery operation S50 and the recovery container changing operation S60 may be omitted and the process may proceed.

In the fluid recovery method using the radionuclide separating apparatus 1 according to the present disclosure, the operations are repeated in a specific order and under specific conditions, and driving of the components is controlled through the controller 50, so that sequentially discharged fluids may be recovered rapidly and accurately. Furthermore, the operations may be performed automatically, so that the time and labor required for the process may be reduced. Furthermore, when the driving member 25 is located below the column container 21, a residual fluid that inevitably remains in the driving member passage 24 may be recovered into an appropriate recovery container 31, so that the recovery rate of the fluid may be increased.

According to the present disclosure, the fluid sequentially discharged during the radionuclide separating process may be rapidly and accurately recovered.

Furthermore, according to the present disclosure, the recovery rate of the fluid may be increased.

The above description is merely an example of the technical idea of the present disclosure, and various modifications and variations may be made by one skilled in the art without departing from the essential characteristic of the present disclosure. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents. Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

What is claimed is:

1. An apparatus for separating a desired radionuclide, the apparatus comprising:
a fluid supply part configured to supply a fluid including a sample containing the radionuclide or a reagent,
a column separation part configured to receive the fluid supplied from the fluid supply part and separate the radionuclide, and including a driving member passage, through which the fluid, from which the radionuclide has been separated, is discharged;
a fluid recovery part including a plurality of recovery containers configured to recover the fluid discharged through the column separation part;
a sensor configured to sense the fluid in the column separation part; and
a controller configured to control driving of the fluid supply part, the column separation part, and the fluid recovery part such that, after residual fluid remaining in an interior of the driving member passage is recovered into the recovery container, the recovery container located at a recovery position is replaced.

2. The apparatus of claim 1, wherein the column separation part includes:
a column container configured to accommodate the fluid supplied by the fluid supply part and having an outlet, through which the fluid is discharged, at one side thereof; and
a driving member configured to provide power such that the fluid flows,
wherein the controller controls the driving member such that the driving member is driven until a sensing time point of the fluid by the sensor.

3. The apparatus of claim 2, further comprising:
an adsorption member disposed in an interior of the column container and configured to adsorb the radionuclide contained in the fluid,
wherein the sensor senses a time point, at which all of the supplied fluid in the interior of the column container flows into the adsorption member.

4. The apparatus of claim 2, wherein the controller is configured to:
control the fluid supply part such that new fluid is supplied to the column container after the sensing time point of the sensor; and
control the column separation part such that, after the new fluid is supplied to the column container, the driving of the column separation part starts to recover the fluid remaining in the driving member passage, and the driving of the column separation part stops when all of the residual fluid has been recovered.

5. The apparatus of claim 4, wherein an internal volume value of the driving member passage is input to the controller, and
the controller controls a driving time period of the column separation part to recover the residual fluid, depending on an input internal volume value of the driving member passage.

6. A fluid recovery method using the radionuclide separating apparatus of claim 1, the fluid recovery method comprising:
a fluid supply operation of supplying a fluid (Lₙ₊₁) to a column container;
a residual fluid recovery operation of recovering residual fluid (Lₙ) remaining in a driving member passage into a recovery container (Cₙ);
a recovery container changing operation of moving the recovery container (Cₙ₊₁) configured to recover the supplied fluid (Lₙ₊₁), to a recovery position; and
a fluid recovery operation of operating a driving member until a sensing time point by a sensor to recover the fluid (Lₙ₊₁) having passed through a column separation part, into the recovery container (Cₙ₊₁).

7. The method of claim 6, further comprising:
a volume input operation of inputting an internal volume value of the driving member passage,
wherein the residual fluid recovery operation is operated for a recovery time period depending on the input internal volume value of the driving member passage.

8. The method of claim 7, wherein in the volume input operation, a time period, for which the residual fluid recovery operation is operated, is calculated depending on the internal volume value of the driving member passage.

9. The method of claim 6, further comprising:
an operation of determining whether the operation is a final operation of a radionuclide separating process.

10. The method of claim 9, wherein an amount of the supplied fluid in the fluid supply operation is adjusted so that a specific amount of the fluid is recovered without using subsequent fluid.

11. The method of claim 10, wherein when it is determined to be the final operation of the radionuclide separating process, in the fluid supply operation, the fluid (Lₙ₊₁) is supplied in an amount obtained by adding an amount required for the radionuclide separating process and an amount corresponding to the internal volume value of the driving member passage.
